(19) United States
(12) Patent Application Publication
(10) Pub. No.: US 2009/0240876 A1
(43) Pub. Date: Sep. 24, 2009

(54) Information processing apparatus, information processing method and storage system

(75) Inventors: Takahide Okuno, Odawara (JP); Tatsuya Sumino, Chigasaki (JP); Mitsuhide Sato, Oiso (JP); Ryosuke Matsubara, Odawara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/153,417

(22) Filed: May 19, 2008

(30) Foreign Application Priority Data
Mar. 24, 2008 (JP) 2008-076430

(51) Int. Cl. G06F 12/00

(52) U.S. Cl. 711/110; 711/E12.001

(57) ABSTRACT

Provided is an information processing apparatus including a local memory for storing a control program, a flash memory for storing a boot program, a processor for controlling the overall controller, a chipset for relaying the transfer of data among the respective components, and a logical control circuit arranged between the chipset and the flash memory. The logical control circuit performs information conversion processing to accommodate the logical configuration of the chipset and the flash memory when sending and receiving information between the chipset and the flash memory. This information conversion processing includes the steps of translating a serial address signal output from the chipset into a parallel address signal, translating a serial data signal output from the chipset into a parallel data signal, and translating a parallel data signal output from the flash memory into a serial data signal.

### CROSS-REFERENCES

This application relates to and claims priority from Japanese Patent Application No. 2008-076430, filed on Mar. 24, 2008, the entire disclosure of which is incorporated herein by reference.

### BACKGROUND

The present invention relates to information processing technology of an information processing apparatus to be used in a storage system or the like connected to a communication network.

Conventionally, an information processing apparatus has been proposed which comprises a processor, a memory, an interface controller, and a system controller for controlling the communication among the processor and the memory and the interface controller. With this information processing apparatus, when transferring data between the memory and the system controller, the system controller determines whether to add an error detection signal for protecting data based on the address of the memory where the data to be transferred will be read and written so as to protect the data (refer to Japanese Patent Laid-Open Publication No. 2007-207062).

With this kind of information processing apparatus, there is a type that stores a control program in a main memory, stores a boot program in a flash memory, arranges a chipset or a system controller between a processor and the flash memory, and relays the transfer of data with the chipset or the system controller. In this information processing apparatus, by arranging the chipset or the system controller between the processor and the flash memory, the chipset or the system controller is able to directly access the flash memory.

### SUMMARY

With the foregoing conventional technology, although the chipset or the system controller is able to directly access the flash memory by arranging the chipset or the system controller between the processor and the flash memory, if the specification of the processor or the chipset is changed, the chipset will not be able to directly access the flash memory if the chipset is simply connected to the flash memory.

Thus, an object of the present invention is to propose an information processing apparatus, an information processing method and a storage system using this information processing apparatus capable of accessing the flash memory in accordance with the chipset configuration even if the chipset specification is changed.

In order to achieve the foregoing object, the present invention arranges a logical control circuit between a chipset and a flash memory, and causes the logical control circuit to execute information conversion processing for accommodating the logical configuration of the chipset and the flash memory when sending and receiving information between the chipset and the flash memory.

According to the present invention, the flash memory can be accessed in accordance with the chipset configuration.

### DESCRIPTION OF DRAWINGS

FIG. 1 is a block configuration diagram of a storage system showing the first embodiment of the present invention;

FIG. 2 is a block configuration diagram of a logical control circuit;

FIG. 3 is a block configuration diagram explaining the relationship of a logical control circuit and a flash memory;

FIG. 4 is a flowchart explaining the read/write access to the flash memory;

FIG. 5 is a mapping configuration diagram of a flash area in a memory space;

FIG. 6 is a configuration diagram explaining the relationship of a logical control circuit and a flash memory in the second embodiment of the present invention;

FIG. 7 is a flowchart explaining the working of the second embodiment;

FIG. 8 is a diagram explaining the relationship of a linear address and a physical address in a BIOS area;

FIG. 9 is a block configuration diagram of a logical control circuit in the third embodiment of the present invention; and

FIG. 10 is a flowchart explaining the working of the third embodiment.

### DETAILED DESCRIPTION

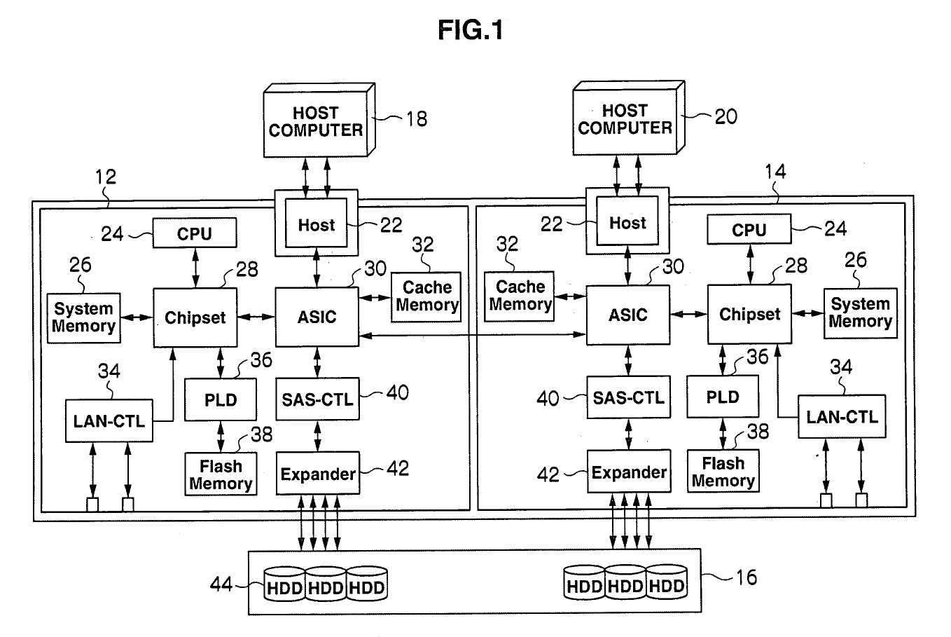

An embodiment of the present invention is now explained with reference to the attached drawings. FIG. 1 is a block configuration diagram of a storage system applying an information processing apparatus according to the present invention. In FIG. 1, the storage system 10 comprises controllers 12, 14, and a storage apparatus 16, and each controller 12, 14 is connected to the storage apparatus 16, and additionally connected to host computers (host systems) 18, 20 via a communication network (not shown).

The controllers 12, 14, as a dual configuration information processing apparatus, comprise a host controller 22, a processor (CPU) 24, a local memory 26, a chipset 28, a data transfer controller 30, a cache memory 32, a LAN (Local Area Network) controller 34, a logical control circuit 36, a flash memory 38, a SAS (Serial Attached SCSI) controller 40, and an expander 42. The host controller 22 is connected to the host computers 18, 20, and the expander 42 is connected to the storage apparatus 16. The storage apparatus 16 comprises a plurality of nonvolatile storage mediums 44 such as hard disk drives (HDD). Since the controller 12 and the controller 14 are configured the same, the ensuing explanation will focus only on the controller 12.

The host controller 22 in the controller 12 is configured as an interface for controlling the communication with the host computer 18, and sending and receiving commands to and from the host computer 18. The processor (CPU) 24 executes processing according to commands from the host computer 18 based on a control program stored in the local memory 26 and a boot program stored in the flash memory 38, and also controls the operation of the overall controller 12.

The chipset 28 relays, with the processor 24, the local memory 26, the flash memory 38 and the data transfer controller 30 as transfer targets, data concerning these transfer targets.

The data transfer controller 30 controls the data transfer between the controller 12 and the controller 14 and the data transfer among the respective components in the controller 12, and is also loaded with a function for dual writing the write data given from the host computer 18 into the cache memory 32 according to a command from the processor 24. The cache memory 32 configures a storage area for temporarily storing data to be transferred by the data transfer controller 30.

The local memory 26 stores various control programs (microprograms), and is also configured as a storage area for temporarily storing various commands such as read commands and write commands given from the host computer 18.

The SAS controller 40 and the expander 42, as a communication controller configuring the interface for controlling the communication with the storage apparatus 16, transfer data controlled by the data transfer controller 30 to the storage apparatus 16, and also transfer data from the storage apparatus 16 to the data transfer controller 30.

The flash memory 38 stores, in addition to a boot program, programs concerning the initialization and diagnosis of the respective devices required upon booting such devices; for instance, programs concerning BIOS (Basic Input/Output System) (hereinafter referred to as “BIOS programs”).

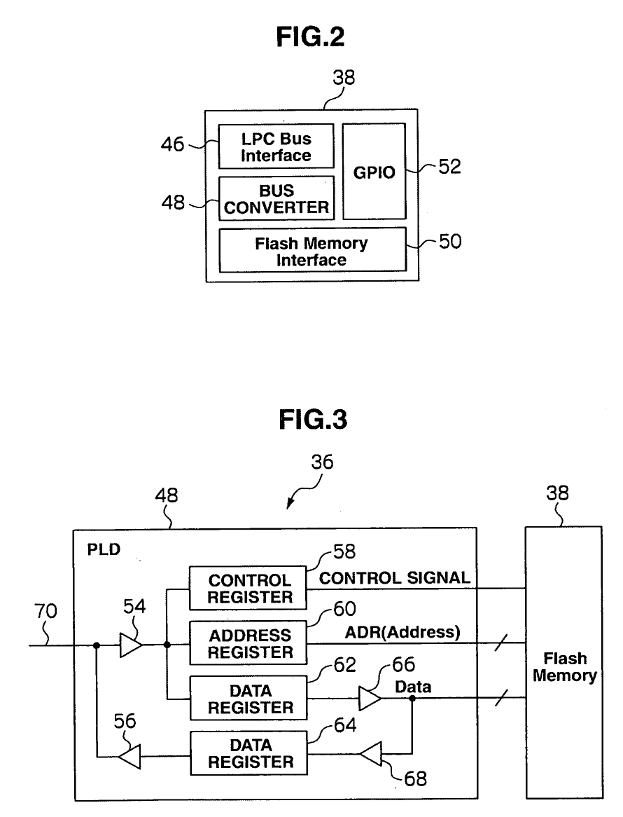

The logic controller 36 is configured as a device, a PLD (Programmable Logic Device) for instance, to be arranged between the chipset 28 and the flash memory 38, and for executing information conversion processing to accommodate the logical configuration of the chipset 28 and the flash memory 38 when sending and receiving information between the chipset 28 and the flash memory 38. The logical control circuit 38, as shown in FIG. 2, comprises an LPC (Low Pin Count) bus interface 46, a bus converter 48, a flash memory interface 50, and a general purpose I/O port (General Purpose Input Output) 52.

The bus converter 48, as shown in FIG. 3, as a device loaded with a LPC (Low Pin Count) bus/flash bus conversion function, comprises buffers 54, 56, a control register 58, an address register 60, a first data register 62, a second data register 64, and buffers 66, 68.

When a signal for accessing the flash memory 38 is input from the chipset 28 via the LPC (Low Pin Count) bus 70 and the buffer 54, the control register 58 creates a control signal for accessing the flash memory 38 to read and write data, and outputs the control signal to the flash memory 38.

The address register 60 converts the memory address (serial address signal) sent by time-sharing as a 4-bit×7 signal from the LPC bus 70 via the buffer 54 into a 24-bit parallel signal, and outputs the converted signal to the flash memory 38.

The first data register 62 converts the data (serial data signal) sent by time-sharing as a 4-bit×2 signal from the LPC bus 70 via the buffer 54 into an 8-bit parallel signal, and outputs the converted signal to the flash memory 38.

Meanwhile, the second data register 64 divides the 8-bit parallel signal sent from the flash memory 38 via buffer 68 into high 4 bits and low 4 bits, and outputs the divided serial data signal to the LPC bus 70 via the buffer 56.

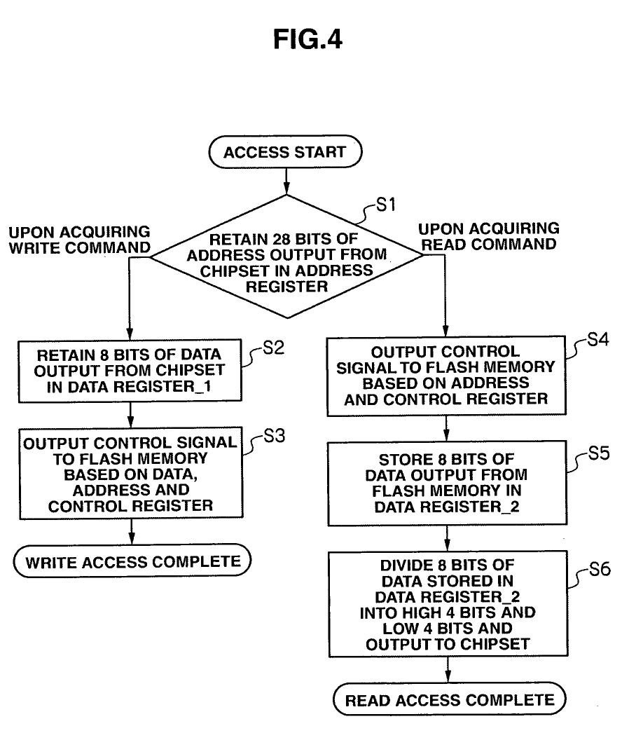

The operation upon performing read/write access to the flash memory 38 using the logical control circuit 36 is now explained with reference to the flowchart of FIG. 4. Foremost, when a 28-bit address signal is output from the chipset 28, the address register 60 of the bus converter 48 retains the 28-bit address signal sent from the chipset 28 (S1). When the bus converter 48 acquires a write command from the chipset 28, the first data register 62 retains the 8-bit data output from the chipset 28 (S2).

The control register 58 thereafter outputs a control signal for write-accessing the flash memory 38, the address register 60 outputs an address signal for specifying the access target to the flash memory 38, and the first data register 62 transfers data to be written to the flash memory 38 (S3). The write access to the flash memory 38 is thereby complete.

Meanwhile, when the bus converter 48 acquires a read command, as processing according to the read command, the control register 58 outputs a control signal for read-accessing the flash memory 38 to the flash memory 38, and the address register 60 outputs an address signal for specifying the access target to the flash memory 38 (S4).

When the 8-bit data is output from the flash memory 38 in accordance with the read access, the 8-bit data is input to the second data register 60 (S5). The second data register 64 divides the input 8-bit data into high 4-bit data and low 4-bit data, and outputs the divided data to the chipset 28 via the buffer 56 (S6). The read access to the flash memory 38 is thereby complete.

According to this embodiment, even in cases where it is not possible to directly connect the chipset 28 and the flash memory 38 in accordance with changes in the specification of the processor 24 and the chipset 28, since the logical control circuit 36 executes information conversion processing to accommodate the logical configuration of the chipset 28 and the flash memory 38 when sending and receiving information between the chipset 28 and the flash memory 38, the processor 24 is able to access the flash memory 38 via the chipset 28 and the logical control circuit 36.

The second embodiment of the present invention is now explained. When the controller 12 is to access the storage apparatus 16 in the storage system 10, programs for (a) device initialization and (b) device diagnosis must be stored in the flash memory 38, and the flash memory 38 needs to have a large capacity. Here, if 32 MB is required as the capacity of the flash memory 38 and the area that can be accessed from the chipset 28 to the flash memory 38 is set to 16 MB, although the chipset 28 will be able to access the low 16 MB area, it will not be able to access the high 16 MB area since it is not mapped to the memory space.

Thus, in this embodiment, a bank switch function is added to the logical control circuit 36 and a flash memory 38 having a capacity of 16 MB+16 MB is used so that a flash memory area that can only be allocated for a capacity of 16 MB in the memory space can be accessed as an area for a capacity of 32 MB.

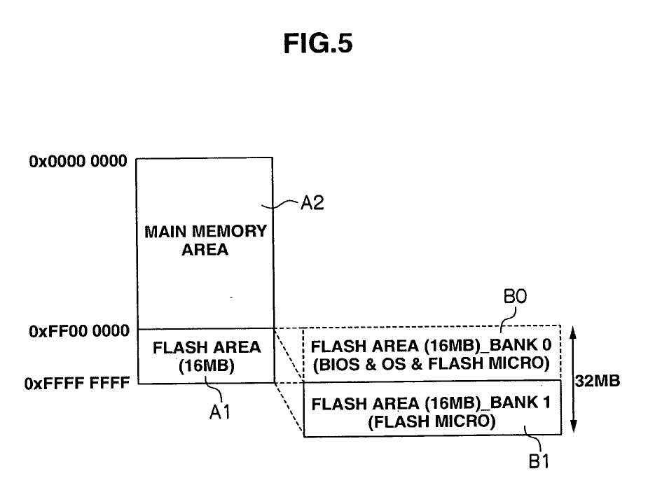

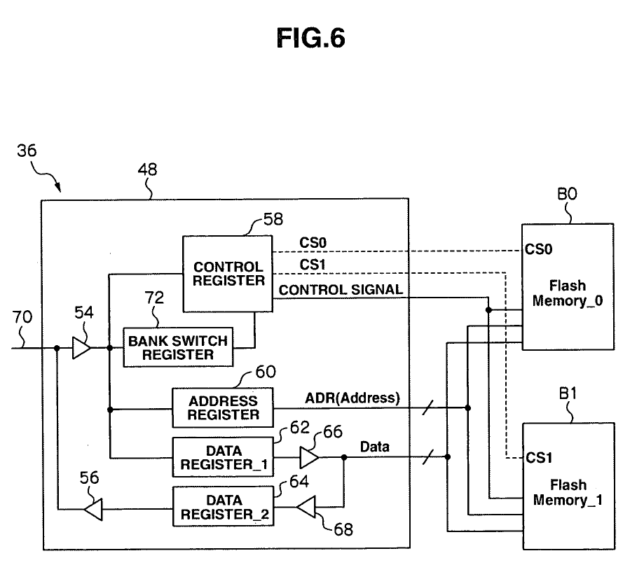

Specifically, as shown in FIG. 5 and FIG. 6, the flash memory 38 comprises a flash area (16 MB) A1 to become the access target of the processor 24, and a 16 MB bank B0 and a 16 MB bank B1 as physical areas corresponding to the flash area (16 MB) A1. When the address of the main memory area A2 is “0x0000 0000” to “0xFEFF FFFF,” the flash area A1 will be allocated with “0xFF00 0000” to “0xFFFF FFFF” as the address. The same address is set to the respective banks B0, B1.

Meanwhile, the bus converter 48 is provided with a bank switch register 72 for commanding switching to select one of the banks B0, B1 in response to an access input from the chipset 28 via the LPC bus 70, and the control register 58 to be used is loaded with a function for outputting a chip select signal CS0 for selecting the bank B0 to the bank B0 when a command for selecting the bank B0 is output from the bank switch register 72, and outputting a chip select signal CS1 for selecting the bank B1 to the bank B1 when a command for selecting the bank B1 is output from the bank switch register 72.

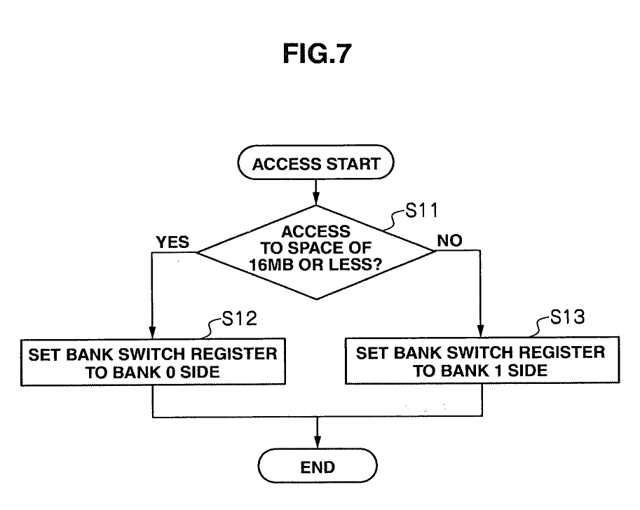

The working of this embodiment is now explained with reference to the flowchart of FIG. 7. Foremost, when the access from the microprocessor 24 is input to the logical control circuit 36 via the chipset 28, the logical control circuit 36 determines whether to access space of 16 MB or less based on a read/write access from the processor 2 (S11), and sets the bank switch register 72 to the bank B0 side when accessing space of 16 MB or less (S12). Thereby, the chip select signal CS0 is output from the control register 58 to the bank B0, the bank B0 is subject to the read/write access, and the processing of this routine is ended.

Meanwhile, if space of 16 MB or less is not to be accessed, the logical control circuit 36 sets the bank switch register 72 to the bank B1 side (S13). Thereby, the chip selector signal CS1 is output from the control register 58 to the bank B1, read/write access is executed to the bank B1, and the processing of this routine is ended.

According to the present embodiment, since the flash memory 38 comprises a flash area (16 MB) A1 to become the access target of the processor 24 and a 16 MB bank B0 and a 16 MB bank B1 as physical areas corresponding to the flash area (16 MB) A1, and the logical control circuit 36 is equipped with a bank switch function for accessing either the bank B0 or the bank B1 when the flash area (16 MB) A1 is accessed, the flash memory area A1 that can only be allocated for a capacity of 16 MB in the memory space can be accessed as an area for a capacity of 32 MB.

The third embodiment of the present invention is now explained. This embodiment explains a case where the flash memory 38 stores a BIOS program in addition to the boot program, and, since a part of the BIOS program will be erased if erase/write processing is executed for each sector in the BIOS program, this embodiment aims to prevent such erasure.

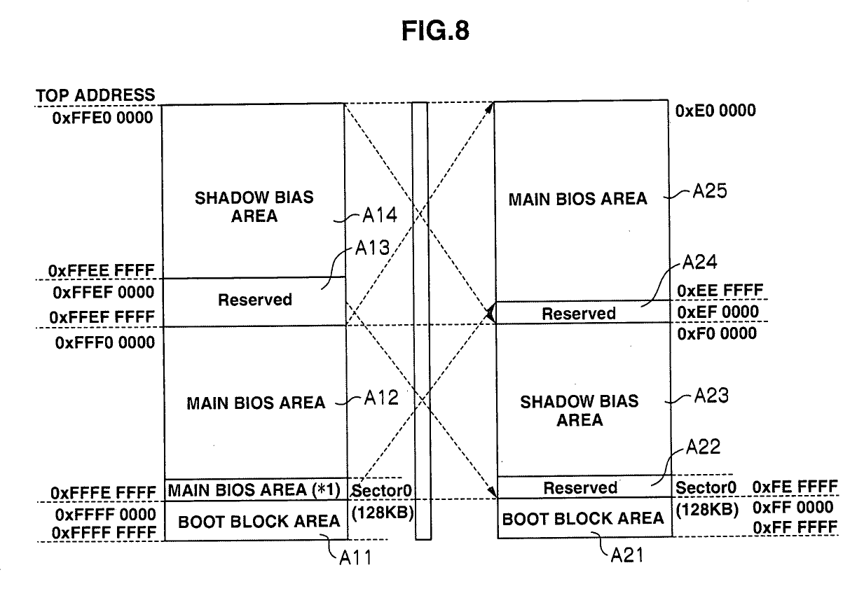

Specifically, when executing the initialization of the microprocessor 24 and the chipset 28 by executing the BIOS program, as shown in FIG. 8, a boot block area (top address “0xFFFF 0000”) A11, a main BIOS area (top address “0xFFF0 0000”) A12, a reserve area (top address “0xFFEF 0000”) A13, and a shadow BIOS area (“0xFFE0 0000”) A14 are allocated as logical areas of the flash memory 38.

The boot block area A11 is an area for storing programs to initialize the processor 24 and the chipset 28, which are the minimal devices required upon turning on the power. The main BIOS area A12 is an area for storing programs to set the configuration of the chipset 28. The shadow BIOS area A14 is a program area to be executed when the main BIOS area A12 is destroyed, and the same programs as the main BIOS area A12 are stored therein. In other words, the main BIOS area A12 and the shadow BIOS area A14 configure redundant BIOS.

Although the boot block area All and the shadow BIOS area A14 are fixed as areas that do not require rewriting, the main BIOS area A12 is an area that is rewritable (supportable) in consideration that the BIOS version may be updated.

Here, although the boot block area A11 and the main BIOS area A12 must set a mutually continuous address (linear address), the erase/write processing is executed for each sector. Thus, for instance, if the boot block area A11 and the main BIOS area A12 are partially contained in the sector 0 (128 KB), the boot block area A11 will be simultaneously erased during the erase/write processing of the main BIOS area A12.

Thus, in this embodiment, the logical control circuit 36 is loaded with an address translation function for translating a logical area configured from the boot block area A11, the main BIOS area A12, the reserve area A13, and the shadow BIOS area A14 into a physical area configured from a boot block area A21, a reserve area A22, a shadow BIOS area A23, a reserve area A24, and a main BIOS area A25.

Here, the logical address of the flash memory 38 is set to “0xFFE0 0000” to “0xFFFF FFFF” and the physical address corresponding to this logical address is set to “0xE00000” to “0xFFFFFF.” If the 20^{th} bit in the address from the chipset 28 is “0,” this corresponds to the areas (shadow BIOS area A14, reserve area A13) of the logical address of “0xFFE0 0000” to “0xFEF FFFF” and if the 20^{th} bit is “1,” this corresponds to the areas (main BIOS area A12, boot block area A11) of the logical address of “0xFFF0 0000” to “0xFFFF FFFF.”

If the logical address of “0xFFE00000” to “0xFFEE FFFF” is subject to address translation when the 20^{th} bit in the address from the chipset 28 is “0,” this logical address is translated into the physical address of “0xF00000” to “0xFEFFFF.” If the logical address of “0xFFF0 0000” to “0xFFFE FFFF” is subject to address translation when the 20^{th} bit in the address from the chipset 28 is “1,” this logical address is translated into the physical address of “0xE00000” to “0xEEFFFF.”

Among the physical areas, the boot block area A21 and the reserve area (unused area) A22 are allocated as areas belonging to the sector 0 (128 KB). The shadow BIOS area A23 and the reserve area A24 of the physical area are set with the physical address (“0xF00000” to “0xFEFFFF”) corresponding to the area partially including the shadow BIOS area A14 and the reserve area A13 of the logical area, and the main BIOS area A25 of the physical area is set with the physical address (“0xE00000” to “0xEEFFFF”) corresponding to the main BIOS area A12 of the logical area.

In other words, the logical address (“0xFFFF 0000” to “0xFFFF FFFF”) of the boot block area A11 is set as an address (linear address) that is continuous from the logical address (“0xFFF0 0000” to “0xFFFE FFFF”) of the main BIOS area A12, and the physical address (“0xE00000” to “0xEEFFFF”) of the main BIOS area A25 is set as an address that is different from the logical address “0xFFF0 0000” to “0xFFFE FFFF” of the main BIOS area A12, and as an address that belongs to a sector (sector 10 for instance) that is different from the sector (sector 0) to which the physical address (“0xFF0000” to “0xFFFFF”) of the boot block area A21 belongs, or as an address that is discontinuous from the physical address (“0xFF0000” to “0xFFFFF”) of the boot block area A21.

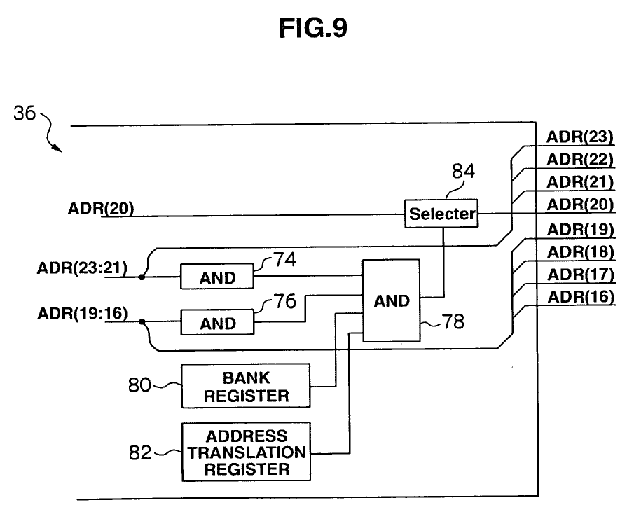

Meanwhile, the logical control circuit 36, as shown in FIG. 9, as a device loaded with the address translation function, comprises AND gates 74, 76, 78, a bank register 80, an address translation register 82, and a selector 84.

The AND gates 74, 76, 78 and the bank register 80 and the address translation register 82 are configured as a determination unit for identifying an address from the chipset and determining whether to perform address translation. The selector 84 is configured as an address translator for translating a logical address for accessing the flash memory among the addresses from the chipset 28 into a physical address when a determination result indicating that address translation is necessary is output from the determination unit, and accessing the flash memory 38 according to the converted physical address.

When a memory address (address signal) is input from the chipset 28 via the LPC bus 70, the logical control circuit 36 retains a 28-bit address signal, and the AND gate 74 determines whether the bits of addresses 23 to 21 are all “1”; that is, whether they are 0xE or 0xF with a hexadecimal number, and the AND gate 76 determines whether the bits of addresses 19 to 16 are all other than “1”; that is, whether they are other than 0xF with a hexadecimal number. The respective AND gates 74, 76 output a signal of “1” to the AND gate 78 when the determination result is positive, and outputs a signal of “0” to the AND gate 78 in all other cases.

When the bank register 80 is set to the bank B0 side and a validation (Enable) signal is being output from the address translation register 82, on the condition that a signal of “1” is being output from the AND gates 74, 76, the AND gate 78 outputs a signal of “1” to the selector 84, and outputs a signal of “0” to the selector 84 in all other cases. The selector 84 inverts the value of the 20^{th} bit of the address (i.e., inverts “0” to “1” or inverts “1” to “0”) while the signal of “1” is being output from the AND gate 78 since this means that all condition are satisfied. Meanwhile, if a signal of “0” is output from the AND gate 78, the signal of the 20^{th} bit of the address is output to the flash memory 38 as is since this means that the conditions have not been satisfied.

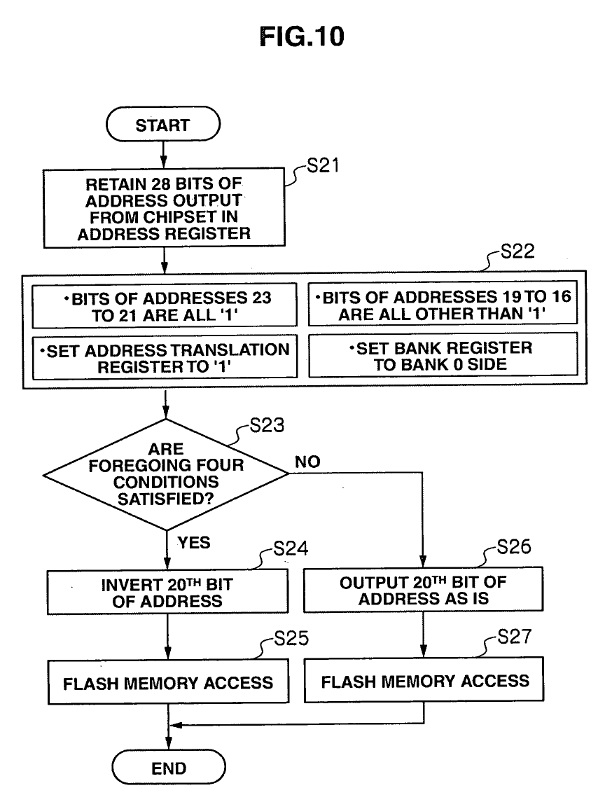

The specific processing contents are now explained with reference to the flowchart of FIG. 10. Foremost, the logical control circuit 36 retains 28 bits of address output from the chipset 28 (S21). Subsequently, with the logical control circuit 36, the AND gate 74 determines whether the bits of addresses 23 to 21 are all “1,” and the AND gate 76 determines whether the bits of addresses 19 to 16 are all other than “1.” Subsequently, the logical control circuit 36 performs processing for setting the address translation register 82 to “1” and setting the bank register 80 to the bank B0 side (S22).

Subsequently, the AND gate 78 in the logical control circuit 36 determines whether the four conditions ((1) bits of addresses 23 to 21 are all “1,” (2) bits of addresses 19 to 16 are all other than “1,” (3) address translation register 82 is “1,” (4) bank register 80 is on bank B0 side) are all satisfied, and outputs the determination result to the selector 84 (S23). If all four conditions are satisfied, the selector 84 inverts the 20^{th} bit of the address (S24), outputs the inverted signal to the flash memory 38, accesses the flash memory 38 (S25), and then ends the processing of this routine.

For example, if the logical address of “0xFFE0 0000” to “0xFFEE FFFF” is subject to address translation, when the 20^{th} bit in the address from the chipset 28 is inverted from “1” to “0,” this logical address is translated into a physical address of “0xF00000” to “0xFEFFFF.” Here, the logical control circuit 36 accesses the reserve area A22 and the shadow BIOS area A23 of the flash memory 38, and executes rewriting/erase processing and the like to the shadow BIOS area A23. Here, even if the erase processing or the like is executed in sector units, since the boot block area A21 belongs to a sector that is different from the shadow BIOS area A23, it is possible to prevent programs and the like stored in the boot block area A21 from being erased.

If the logical address of “0xFFF0 0000” to “0xFFFE FFFF” is subject to address translation, when the 20^{th} bit in the address from the chipset 28 is inverted from “0” to “1,” this logical address is translated into a physical address of “0xE00000” to “0xEEFFFF.” Here, the logical control circuit 36 accesses the main BIOS area A25 of the flash memory 38, and executes rewriting/erase processing and the like to the main BIOS area A25. Here, even if erase processing or the like is executed in sector units, since the boot block area A21 belongs to a sector that is different from the main BIOS area A25, it is possible to prevent programs and the like stored in the boot block area A21 from being erased.

Meanwhile, if the four conditions are not satisfied, the selector 84 outputs the 20^{th} bit of the address as is to the flash memory 38 (S26), accesses the flash memory 38 according to the logical address without performing address translation (S27), and then ends the processing of this routine.

According to the foregoing embodiment, in addition to being able to rewrite the entire main BIOS area A25, even if erasure processing or the like is executed to the main BIOS area A25 in sector units, it is possible to prevent the programs and the like stored in the boot block area A21 from being erased since the boot block area A21 is set in a sector that is different from the main BIOS area A25.

1. An information processing apparatus, comprising:
a processor for performing I/O processing of information to and from a storage apparatus based on a control program;
a flash memory for storing a boot program;
a chipset for relaying, with the processor and the flash memory as transfer targets, information concerning the transfer targets; and
a logical control circuit arranged between the chipset and the flash memory and for executing information conversion processing;
wherein, when sending and receiving information between the chipset and the flash memory, the logical control circuit executes information conversion processing to accommodate the logical configuration of the chipset and the flash memory.

2. The information processing apparatus according to claim 1,
wherein the logical control circuit comprises:
a control register for creating a control signal to the flash memory in response to an access from the chipset;
an address register for converting a serial address signal output from the chipset into a parallel address signal and outputting the converted address signal to the flash memory;
a first data register for converting a serial data signal output from the chipset into a data signal and outputting the converted data signal to the flash memory; and
a second data register for converting a parallel data signal output from the flash memory into a serial data signal and outputting the converted data signal to the chipset.

3. The information processing apparatus according to claim 1,
wherein the flash memory comprises a plurality of banks as a physical area corresponding to a flash area to become an access target of the processor; and
wherein the logical control circuit selects one of the banks as the access target in response to an access from the processor.

4. The information processing apparatus according to claim 1,
wherein the flash memory comprises a plurality of banks as a physical area corresponding to a flash area to become an access target of the processor; and
wherein the logical control circuit comprises:
a bank switch register for commanding switching to select one of the banks in response to an access from the processor; and
a control register for selecting the bank commanded by the bank switch register as the access target of the processor.

5. The information processing apparatus according to claim 1,
wherein the flash memory comprises:
a BIOS area for storing data concerning the configuration of the chipset; and
a boot block area for storing programs concerning the boot setting/initialization;
wherein a logical address of the boot block area is set as an address that is continuous from the logical address of the BIOS area;
wherein a physical address of the BIOS area is an address that is different from the logical address of the BIOS area, and set as an address that is discontinuous from the physical address of the boot block area;
wherein the logical control circuit comprises:
a determination unit for identifying an address from the chipset and determining whether to perform address translation; and
an address translator for translating a logical address for accessing the flash memory among the addresses from the chip into a physical address when the determination result from the determination unit indicates that address translation is necessary; and
wherein the flash memory is accessed according to the physical address translated with the address translator.

6. The information processing apparatus according to claim 1,
wherein the flash memory comprises:
a BIOS area for storing data concerning the configuration of the chipset; and
a boot block area for storing programs concerning the boot setting/initialization;
wherein a logical address of the boot block area is set as an address that is continuous from the logical address of the BIOS area;
wherein a physical address of the BIOS area is an address that is different from the logical address of the BIOS area, and set as an address belonging to a sector that is different from the sector to which the physical address of the boot block area belongs;
wherein the logical control circuit comprises:
a determination unit for identifying an address from the chipset and determining whether to perform address translation; and
an address translator for translating a logical address for accessing the flash memory among the addresses from the chip into a physical address when the determination result from the determination unit indicates that address translation is necessary; and
wherein the flash memory is accessed according to the physical address translated with the address translator.

7. A storage system, comprising:
a storage apparatus including a plurality of storage devices; and
a controller for performing I/O processing of data to and from the storage apparatus in response to a command from a host system;
wherein the controller comprises:
a host controller for controlling the communication with the host system;
a memory for storing a control program;
a flash memory for storing a boot program and programs concerning the boot setting/initialization;
a processor for executing processing according to the command based on the control program and the boot program, and controlling the operation of the overall controller;
a storage controller for controlling access to the storage apparatus;
a data transfer controller arranged between the host controller and the storage controller, and for controlling the transfer of data in accordance with the processing of the processor;
a chipset for relaying, with the processor and the memory and the flash memory and the data transfer controller as transfer targets, data concerning the transfer targets; and
a logical control circuit arranged between the chipset and the flash memory, and for executing information conversion processing to accommodate the logical configuration of the chipset and the flash memory when sending and receiving information between the chipset and the flash memory.

8. The storage system according to claim 7,
wherein the logical control circuit comprises:
a control register for creating a control signal to the flash memory in response to an access from the chipset;
an address register for converting a serial address signal output from the chipset into a parallel address signal and outputting the converted address signal to the flash memory;
a first data register for converting a serial data signal output from the chipset into a data signal and outputting the converted data signal to the flash memory; and
a second data register for converting a parallel data signal output from the flash memory into a serial data signal and outputting the converted data signal to the chipset.

9. The storage system according to claim 7,
wherein the flash memory comprises a plurality of banks as a physical area corresponding to a flash area to become an access target of the processor; and
wherein the logical control circuit selects one of the banks as the access target in response to an access from the processor.

10. The storage system according to claim 7,
wherein the flash memory comprises a plurality of banks as a physical area corresponding to a flash area to become an access target of the processor; and
wherein the logical control circuit comprises:
a bank switch register for commanding a switch to select one of the banks in response to an access from the processor; and
a control register for selecting the bank commanded by the bank switch register as the access target of the processor.

11. The storage system according to claim 7,
wherein the flash memory comprises:
a BIOS area for storing data concerning the configuration of the chipset; and
a boot block area for storing programs concerning the boot setting/initialization;
wherein a logical address of the boot block area is set as an address that is continuous from the logical address of the BIOS area;
wherein a physical address of the BIOS area is an address that is different from the logical address of the BIOS area, and set as an address that is discontinuous from the physical address of the boot block area;
wherein the logical control circuit comprises:
a determination unit for identifying an address from the chipset and determining whether to perform address translation; and
an address translator for translating a logical address for accessing the flash memory among the addresses from the chip into a physical address when the determination result from the determination unit indicates that address translation is necessary; and
wherein the flash memory is accessed according to the physical address translated with the address translator.

12. The storage system according to claim 7,
wherein the flash memory comprises:
a BIOS area for storing data concerning the configuration of the chipset; and
a boot block area for storing programs concerning the boot setting/initialization;
wherein a logical address of the boot block area is set as an address that is continuous from the logical address of the BIOS area;
wherein a physical address of the BIOS area is an address that is different from the logical address of the BIOS area, and set as an address belonging to a sector that is different from the sector to which the physical address of the boot block area belongs;
wherein the logical control circuit comprises:
a determination unit for identifying an address from the chipset and determining whether to perform address translation; and
an address translator for translating a logical address for accessing the flash memory among the addresses from the chip into a physical address when the determination result from the determination unit indicates that address translation is necessary; and
wherein the flash memory is accessed according to the physical address translated with the address translator.

13. An information processing method for accessing a storage apparatus according to processing of a processor [in an information processing apparatus] comprising a processor for performing I/O processing of information to and from a storage apparatus based on a control program, a flash memory for storing a boot program, a chipset for relaying, with the processor and the flash memory as transfer targets, information concerning the transfer targets, and a logical control circuit arranged between the chipset and the flash memory and for executing information conversion processing,
wherein the logical control circuit comprises a step of executing information conversion processing to accommodate the logical configuration of the chipset and the flash memory when sending and receiving information between the chipset and the flash memory.

14. The information processing method according to claim 13,
wherein the flash memory comprises a plurality of banks as a physical area corresponding to a flash area to become an access target of the processor; and
wherein the logical control circuit comprises a step of selecting one of the banks as the access target in response to an access from the processor.

15. The information processing method according to claim 13,
wherein the flash memory comprises:
a BIOS area for storing data concerning the configuration of the chipset; and
a boot block area for storing programs concerning the boot setting/initialization;
wherein a logical address of the boot block area is set as an address that is continuous from the logical address of the BIOS area;
wherein a physical address of the BIOS area is an address that is different from the logical address of the BIOS area, and set as an address that is discontinuous from the physical address of the boot block area;
wherein the logical control circuit comprises:
a step for identifying an address from the chipset and determining whether to perform address translation;
a step for translating a logical address for accessing the flash memory among the addresses from the chip into a physical address based on the determination result indicating that address translation is necessary; and
a step for accessing the flash memory according to the physical address converted at the foregoing step.

16. A program for causing a computer to execute an information processing method for accessing a storage apparatus according to processing of a processor [in an information processing apparatus] comprising a processor for performing I/O processing of information to and from a storage apparatus based on a control program, a flash memory for storing a boot program, a chipset for relaying, with the processor and the flash memory as transfer targets, information concerning the transfer targets and a logical control circuit arranged between the chipset and the flash memory and for executing information conversion processing,
wherein the logical control circuit comprises a step of executing information conversion processing to accommodate the logical configuration of the chipset and the flash memory when sending and receiving information between the chipset and the flash memory.
